(19) United States
(12) Patent Application Publication
(10) Pub. No.: US 2003/0107760 A1
(43) Pub. Date: Jun. 12, 2003

(54) System and a method for transferring digital images data to archiving and for print ordering

(76) Inventors: Chao King, Fremont, CA (US); Albert Lieu, Union City, CA (US); Phyllis Catura, San Jose, CA (US); Yoshitaka Ota, Hino (JP)

Correspondence Address: Cameron Kerrigan, Squire, Sanders & Dempsey, L.L.P., Suite 300, One Maritime Plaza, San Francisco, CA, 94111-3492, US

(21) Appl. No.: 10/015,141

(22) Filed: Dec. 10, 2001

(51) Int. Cl. B41J 1/00; G06F 15/00

(52) U.S. Cl. 358/1.15

(57) ABSTRACT

There is described a system and a method for transferring digital image data for archiving and for ordering photographic prints through the network between a photofinisher and a customer.

### FIELD OF THE INVENTION

This invention relates to a system and a method by which customer drops photographic films or hard copies to a photofinisher and expect to receive the photographic prints and corresponding digital image data to be sent to customer's accessible address with simple steps of logging-on photo finisher's web site. The customers can save the digital image data in the place accessible for them such as their own computers or their home page web sites for archiving, distribution and print or re-print ordering.

### DESCRIPTION OF THE RELATED ART

In conventional photography, customer uses the photographic negative film to produce the photographic prints. When extra reprints are needed, the photographic film has to take the processing laboratory (which is also called photofinisher). Under the situation to reprint using the photographic film, there were some difficulties because sometimes the photographic films were lost, and it was also hard to distinguish which is the correct image to be reprint. Furthermore, the customer has to take the photographic film or original hard copy to the processing laboratory when customer orders to reprint. The improvements for those are needed for a long time.

Recently, digital cameras or the equipments capable of exchanging digital images become popular. In the users of such equipments, some have needs to get the photographs of the digital images. To meet for such needs and to obtain reprint orders from such users, there are web sites which offer the reprint order service, for example by the photographic film making and processing company. If there is an order to reprint through the web site, the company contacts the photofinisher to make a print. The current such web sites also give the various services such as storing image data uploaded by the user or giving address to exchange customer's image data to their friends on the supplier's web site, which web site is accessible to their friend through their E-mail Address, and so on. However, for such web sites, the web site suppliers have to prepare storage device having very large storage capability and CPU having high processing capability to respond lots of user's demand as well as to take maintenance such devices. Therefore, the suppliers have paid the high cost to get reprint orders. On the contrary, customers have needs not to be deleted the image data by the supplier if the suppliers go bankrupt or change policy to store the data, as well as not to be deleted or tampered with the image data by the other person.

In view of foregoing problems, firstly a system or a method in which even though the hard copies or developed photographic films are not stored, the customer can order print or additional print easier is desired. Further, secondly a system or a method in which customer can easily find out the image they want to reprint, and it is not necessary to take the films or hard copies to photofinisher to reprint is desired. Further, thirdly, a system or a method in which the customers can easily share the image data with their friends, family or relative through the network is also desired.

### SUMMARY OF THE INVENTION

In accordance with aspects of the present invention that:

1 A print ordering method comprising the steps of:

a) scanning a first image data on an original,

b) storing the scanned first image data during prescribed time on a first storage member,

c) transmitting a second image data corresponding to the first image data from a first terminal to a second terminal through the network,

d) selecting an image data to be printed from the second image data,

e) transmitting an information of the image data to be printed to order the print from the second terminal to the first terminal and

f) printing based on the scanned first image data stored in the first storage member which corresponds to the information of the image data to be printed.

2. The method of any preceding items, further comprising selecting an image data to be downloaded to a second storage member.

By making this embodiment, the customer does not need to keep the original such as photographic film for reprinting. Therefore, the customer can save the space as well as process the image data.

3. The method of any preceding items, wherein the second storage member is installed at Internet Service Provider.

By making this embodiment, the customers can share their image data with their friends, family and relatives easily. In addition, there can be no necessity to prepare the rapid CPU or storage member capable of storing huge data by the photofinisher or film maker.

4. A method for ordering a print and sending an digital image from processing laboratory having a first terminal to a customer having a second terminal through a network, comprising the steps of:

a) scanning an image data on an original,

b) linking the scanned image data with a customer identification information,

c) storing the scanned image data during prescribed time on a first storage member installed at a location accessible for a person in the processing laboratory,

d) transmitting a compressed image data obtained by compressing the scanned image data from the first terminal to the second terminal through the network,

e) selecting, by the customer, a particular image data which the customer needs to print or download from the compressed image data transmitted to the second terminal,

f) transmitting the particular image data to order for printing the particular image data from the second terminal to the first terminal,

g) selecting the scanned image data stored in the first storage member according with the particular image data transmitted from the second terminal, and

h) printing at the processing laboratory the selected image data stored in the first storage member.

5. The method of any preceding items, wherein a size of the compressed image data from the first terminal to the second terminal is determined by storage capability of the second terminal and transmittance speed to the second terminal.

By making this embodiment, the communication between the first terminal and the customer is smoothly and rapidly.

6. A method for ordering a reprint and sending a digital image from a processing laboratory having a first terminal to a customer having a second terminal through a network, comprising the steps of:

a) scanning an image data on an original which the customer has,

b) linking the scanned image data with a customer identification information,

c) storing the scanned image data during prescribed time on a first storage member installed at a location accessible for a person in the processing laboratory,

d) printing the image data,

e) transmitting a compressed image data obtained by compressing the scanned image data from the first terminal to the second terminal through the network,

f) selecting, by the customer, a particular image data which the customer needs to reprint or download from the compressed image data transmitted to the second terminal,

g) transmitting the particular image data to order for reprinting the particular image data from the second terminal to the first terminal,

h) selecting the scanned image data stored in the first storage member according with the particular image data transmitted from the second terminal, and

h) reprinting at the processing laboratory the selected image data stored in the first storage member.

7. A system for ordering a print and sending a digital image from processing laboratory comprising:

a) a scanner for scanning an image data on an original,

b) a first storage member for storing the scanned image data during prescribed time,

c) a software readable first terminal for transmitting and receiving the image data through the network,

e) a printer for making an image based on a information transmitted from a second terminal for transmitting and receiving the image data accessible for a customer, and

f) a software for transmitting the scanned image data from the first terminal to a customer, searching the scanned image data stored in the first storage member which accords with an information transmitted from the second terminal, transmitting the information of the searched image data to the printer to print, and transmitting a E-mail informing the print is ready,

wherein the printer, the scanner and the software readable first terminal are connected through the network.

### BRIEF DESCRIPTION OF THE DRAWINGS

FIG. 1 is a drawing showing an overview of the embodiment of a print ordering system of the present invention.

FIG. 2 is a flowchart of preferred embodiment.

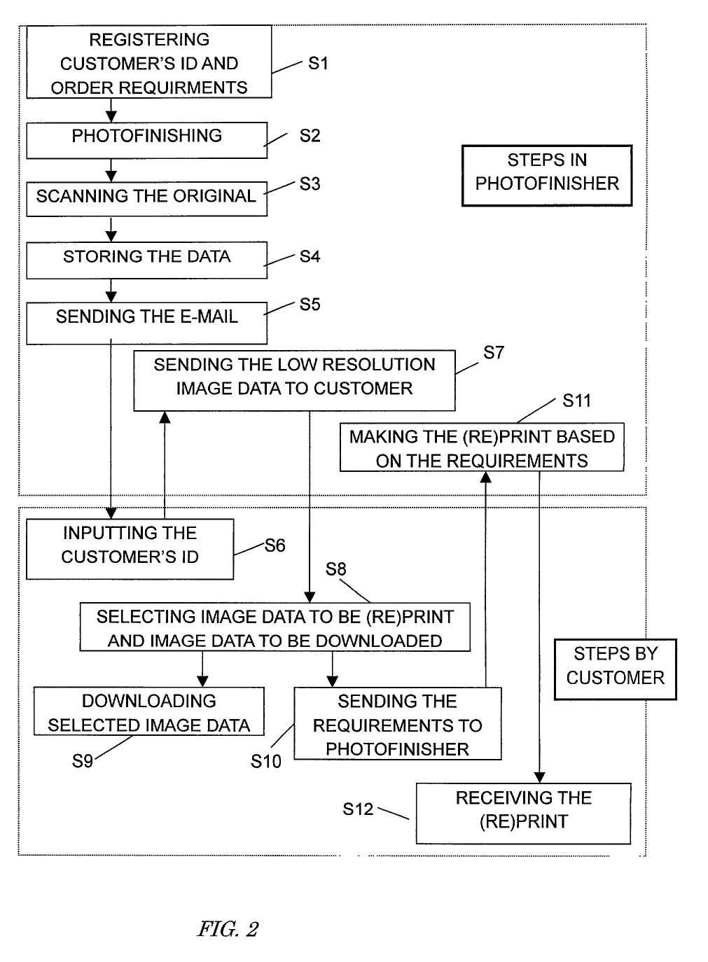

FIG. 3 is a drawing showing an example of ordering display for the shop server to generate printing and scanning orders.

FIG. 4 is a drawing showing the example of the display to enter the photofinisher's web site.

### DETAIL DESCRIPTION OF THE PREFERRED EMBODIMENTS

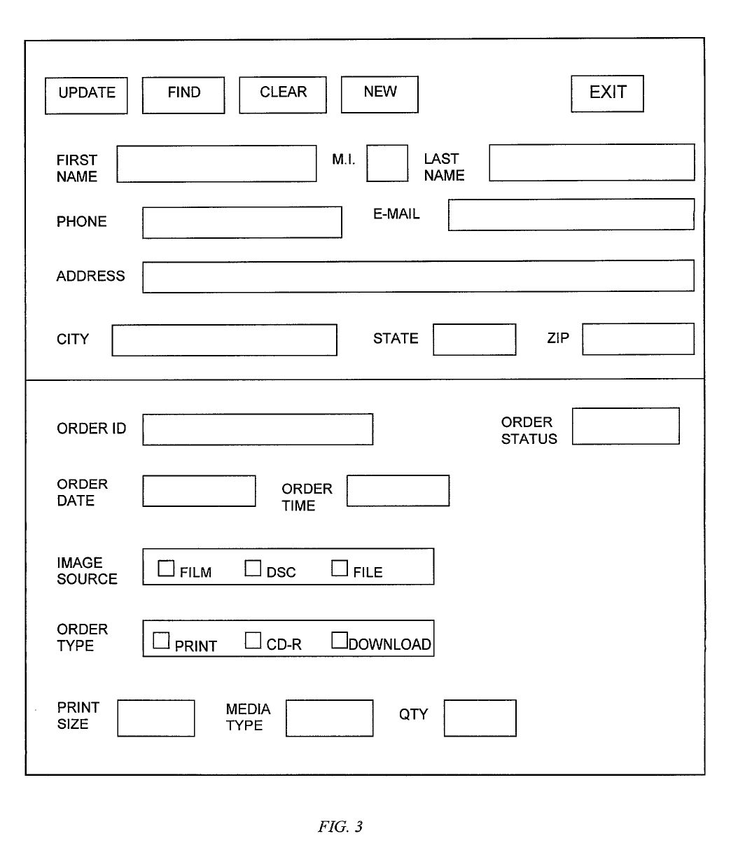

When the photographic film such as a photographic negative film and a photographic reversal film is passed to the photofinisher, the operator at the photofinisher confirms and registers at least following a) and b) into a server 1 at photofinisher (S1) as shown in FIG. 3.

a) the customer identification information such as the customer's name, E-mail address, address, postal code, phone number, facsimile number, etc.

b) order requirements such as

1) what figure the customer needs such as both prints and digital images, either one of prints or digital images;

2) what the customer needs as for printing such as amount of prints, print size, print surface, whether the customer needs index print, a material on which an image is printed such as a paper, a shirt, a cup and a plate; and

3) the others such as

how to receive the printed materials such as mailing and picking up themselves

In the present invention, although kinds of a) and b) are not restricted, a) should be included at least network terminal address such as E-mail address. It may be decided in each photofinisher.

Next, the photographic film is processed by the film processor 7 (S2). Thereafter, the processed photographic films or printed materials are scanned by a scanner 8 (S3) and printed by the printer if ordered.

The kind of printer type which may be used in the present invention is not limited. For example, a printer for photographic paper, an ink jet printer, a thermal printer of sublimation type, a thermal printer of transfer type and etc. are usable corresponding to the material on which the image is printed.

According to the present invention, it is desirable that using a processing apparatus which comprises a processing section to develop, fix and/or bleach the photographic film such as the film processor 7, a printing section for printing the picture on the photographic paper such as the printer 9, and scanning section to scan the objects such as the scanner 8. Such processing apparatus is disclosed for example in U.S. Pat. No. 5,861,942.

In the present invention, the processing apparatus which comprises the printer for photographic paper, being connected to the other printing section such as the inkjet printer or the thermal printer through the network is preferable. In this constitution, if the customer requests the material on which the image is printed other than photographic paper, the image can be easily printed by inkjet printer, thermal transfer printer and so on based on the image data transmitted through a first network 11. The first network 11 means network to connect the equipments necessary for photofinisher including internal network and external network such as internet.

The image from the photographic films or printed materials should be scanned in high resolution mode. Preferably, each image is scanned at not less than 2000×3000 pixels to obtain the picture having high image quality, and each pixel contains three colors channels and each channel in eight bits depth.

The scanned image data are stored by a first storage member 4 on a storage medium (S4). In the present invention, the model or recording form of the first storage member 4 and the storage medium is not specifically limited. For example, as for the first storage member 4, a magnetic recording device, photo magnetic device etc. is usable. As for the magnetic medium, magnetic recording medium such as discs including a floppy disk, a zip, a hard disc and tapes including a DAT, photo magnetic recoding medium such as DC-R, Semiconductor medium such as PCMCI card, DVD, CD-R and so on are also acceptable to record the image data.

The scanned image data, preferably with customer's ID information are stored for prescribed time. Although the time for storing the image data may be decided due to the photofinisher's intent, informing the customer the storage time is preferable to receive the order for printing and downloading the image data explained later. It is preferable to inform the image data storage time when the customer passes the photographic film to the photofinisher or orders the digital image data.

After scanning, the scanned image data is sent to the server 1 to process the image data. The image data are processed to a high resolution image for storing, printing and downloading and a low resolution image for transmitting to the customer for order such as index thumbnail display.

The server 1 will make the low resolution images by compressing the image data. According to the present invention, although the compressing way is not limited, compressing these images with JPEG algorithm is preferable to save space and time when sending these image data to the customer through the second network 12 which is normally internet. It is preferable that all image data obtained from the same photographic film will be kept in a special holder under the name of the Order ID. This image holder will be opened when the customer is linked through the first network 11 and ready to download or when printing.

In the present invention, function to process digital image data means a function capable of various kinds of image processing such as compression, expansion and composition. Further, to explain it concretely, it means an apparatus which is capable of carrying out all kinds of processes relating to image processing, that is, not only reduction of plural images into an image by pasting an compression/expansion, but also a layout processing such as pasting of character data, retouch processing which applies some treatment to an original image, filtering or edge processing for emphasizing the sharpness of an image, noise procession for controlling the feeling of ruggedness, color correction for correction the color balance, the density correction processing, etc. With respect to the various kinds of image processing, it is appropriate for the apparatus to have a function to carry out the processing automatically, or to have a function to carry out it manually by software. Usually, image processing is carried out through software for enabling it by a PC, but it is possible to use a hardware apparatus provided with also an image processing portion.

After scanning or image processing, the E-mail to the customer is sent from the first terminal which may be server 1, based on the information received when the customer took the photographic film to the photofinisher (S5). The E-mail to be sent to the customer has at least information that the digital image data are ready for downloading. It is preferable that the E-mail contains information that the digital image data are ready for downloading because the customer may change his needs when he receives the E-mail. If the customer ordered the print, the E-mail may contain the information that the condition whether the print is ready for picking up or mailing the customer, or not.

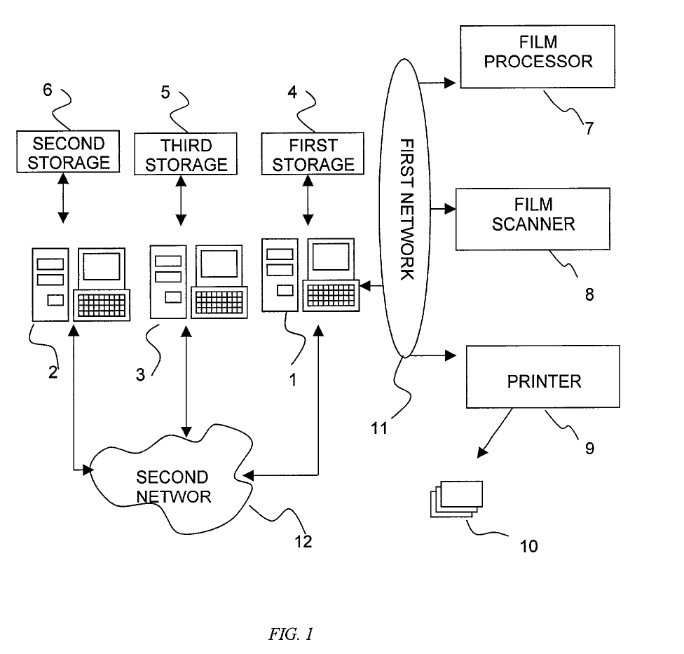

In the present invention, the first terminal means an apparatus or a system including an apparatus or devices, having functions of at least sending and receiving digital information such as image data, customer's ID information, etc. connected through the network which may be external network such as internet, preferable in addition to internal network. The first terminal may be a server 1 at photofinisher as described above or the other server installed on the other place connected to the server 1 at photofinisher via internet. It is preferable the first terminal is linked with film scanner 8, film processor 7 and/or printer 9 through first network 11 as shown in FIG. 1.

Furthermore, the first terminal may have at least one storage member to store the image data or customers information on the storage medium or may be connected the storage member through network 11. The storage member may be the fist storage member 4. The storage member is also not limited as for recording form or model.

When the customer receives E-mail from the first terminal, the customer accesses the photofinisher's web site. In the present invention, the E-mail is preferably set up so that the customer can access the photo finisher's web site when the customer simply clicks on the web address which is attached in the E-mail.

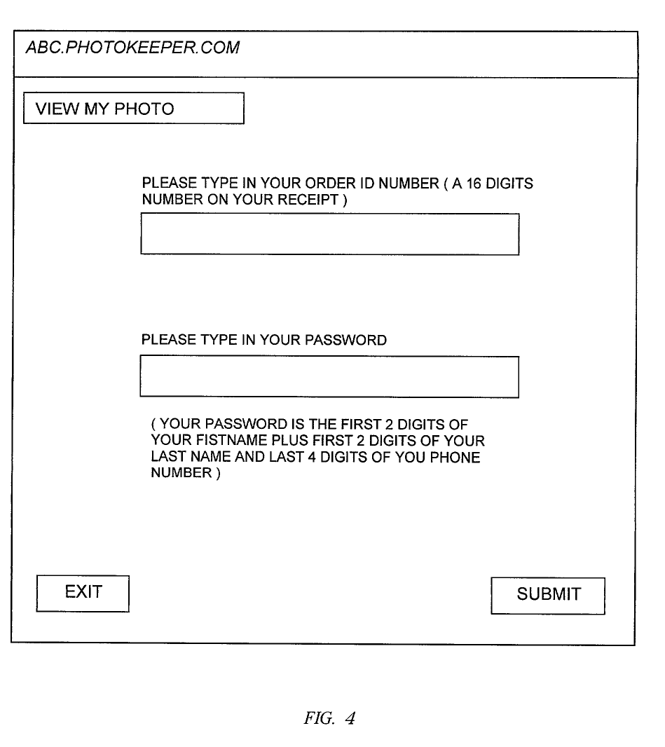

After entering the photofinisher's web site, the customer keys in their ID information required by the web site such as name, Order ID and pass word on displayed page (S6) which were given at passing the photographic films to the photofinisher as shown in FIG. 4. The data inputted by the customer are sent to the first terminal and checked whether the inputted data and customer ID information stored by the first storage member 4 is correct or not. The information inputted by the customer and the information reserved at photofinisher are accorded, the reduced size images will be sent to the second terminal for browsing and selection on the customers display (S7).

If there is no data accorded with the data inputted by the customer finally, the communication between photofinisher and the customer is quitted.

The reduced size may be decided in consideration of memory of the server in photofinisher, first terminal or second terminal, communication speed due to the CPU of the terminals and the network, etc.

The second terminal means an apparatus or a system including apparatus or devices, both of which can send and receive digital information through the second network 12. The second terminal may include or be connected through the network to the second storage member 6 to store the data such as image data transmitted from the first terminal. For example, the second terminal includes a computer 2 accessible for the customer such as the customer's home.

According to the present invention, the customer can select web sites as the second storage member 6, that web sites are offered by internet service provider so as to make the customer's home pages since the customer usually connects the network 12 such as internet through the customer's internet service provider. When the customers select web sites as his storage member, the photofinisher serves the customers software with E-mail or separately so as to the image data can be stored in the web sites.

By this constitution, the customer can share the image data with other persons easily through network 12 even though the customer does not have in touch with them. The other persons can connect the image data by their home computers 3 whenever they want to see and also can store the image data on their storage members 5 through the second network 12 such as internet. In addition, for the company which had currently given the digital image data storage service on the web, there is less maintaining fee because there is no need to install the storage member by supplier itself.

After receiving the reduced size of the image, the customer selects the reduced and low resolution images to download the high resolution image as well as to print or reprint (S8). In the same time, it is preferable that the customer can selects the place where the customer downloads the image data such as the customer's web site and home computer as the second storage.

Once the image data are downloaded, the customers can save the data in the second storage member such as their local computer storage or other devices (S9). If the customer wants to order prints or reprints, the customer selects the image which the customer wants on the display (S8). In the present invention, it is preferable that the customer can select the image by dragging them to the shopping cart icon on the web page. By this constitution, it is easy for the server 1 at photofinisher to recognize correctly the images to be ordered and print. If image is to be removed from the shopping cart, the customer can simply select and drag the images out of the shopping cart.

Once the selection is completed, following steps that the customer selects the order type of prints such as amount, size, print surface or the material on which the image is printed, keys in their payment method, how to receive the prints or reprint such as mailing or picking up at photofinisher, and personal ID number are preferable. Subsequently, the order is sent to the photo finisher for printing or reprinting (S10).

When the order to download is received from the second terminal to the first terminal, the high-resolution image data will be also sent with each image ordered by the customer. When the photofinisher received the print order, the server at photofinisher will place the order and image data into the storage area. Based on the order, the server will then issues a printer order to the printer, which include the size of the prints, quantity of each print with each rendered image data. The printer will then produce or print each images on the material the customer selected (S11).

Once the print order is fulfilled, a message will be sent from the printer back to the server. Then the server will search the database for ordering and customer information, and send an e-mail to the customer stated that the printer order is completed. The customer will receive by the way which the customer designated on the selection (S12). Once the prints are picked up or sent to the customer, the operator in the photo finisher records that the order is picked, the server saves it in the database and order is completed.

At the photofinisher, it is important not to mix up the customer's information with the other customer's films. In the present invention, it is preferable to avoid such confusion by following constitution.

When the photographic film is passed from customer to the photofinisher, the operator will type in the customer's information and order requirement into a server 1 in the photofinisher. The server 1 takes the order and generates a unique order ID number and prints customer identifying information.

This order ID is recorded and then issued from the server 1 at the photofinisher to the processor 7, digital scanner 8 and/or printer 9. When new orders are sent to the processor 7, scanner 8 and/or printer 9, the operator checks the order ID number and place the matching number of the processed film to be scanned and printed to the scanner 8 and scanning will assume.

As for the customer identifying information, the barcode label is preferable. In the case of the barcode is employed, at least four barcode labels are needed for one order. One label is attached to the customer receipt, and given to the customer for later prints pick up. The second label is attached to the prints envelop which contains the photographic film from the customer. Once the photographic film is processed, the third barcode label is attached on the processed photographic film strip. The operator at photofinisher takes the processed film to a printer 9 which may have scanning function to produce the photographic prints 10.

As described in the foregoing, according to the present invention, it is possible to provide a print order method or system which are capable of solving the desires as described above and obtaining the superior effects of at least a) the customer can order prints or reprints easier, even though the hard copies or developed photographic films are not stored, b) the customer can easily find out the image they want to reprint, and it is not necessary to take the films or hard copies to photofinisher to reprint, c) the customers can easily share the image data with their friends, family or relative through the network, and d) there can be no huge storage member to store the customer image data and maintenance cost.

What is claimed is:

1. A print ordering method comprising the steps of:
a) scanning a first image data on an original,
b) storing the scanned first image data on a first storage member,
c) transmitting a second image data corresponding to the first image data from a first terminal to a second terminal through a network,
d) selecting an image data to be printed from the second image data,
e) transmitting an information of the image data to be printed to order the print from the second terminal to the first terminal and
f) making a print based on the scanned first image data stored in the first storage member which corresponds to the information of the image data to be printed.

2. The method of claim 1, wherein the original is a photographic film or a hard copy.

3. The method of claim 1, further comprising the step of sending the information that picking up the prints is ready from the first terminal to the second terminal.

4. The method of claim 1, wherein the second image data is compressed from the first image data.

5. The method of claim 1, wherein the steps a), b), c) and f) are taken place at a processing laboratory.

6. The method of claim 1, further comprising the step of selecting an image data to be downloaded to a second storage member.

7. The method of claim 6, wherein the image data to be downloaded is downloaded at higher resolution than the second image data.

8. The method of claim 6, wherein the second storage member is installed at Internet Service Provider.

9. A method for ordering a print and sending an digital image from a processing laboratory having a first terminal to a customer having a second terminal through a network, comprising the steps of:
a) scanning an image data on an original
b) linking the scanned image data with a customer identification information,
c) storing the scanned image data on a first storage member installed at a location accessible for a person in the processing laboratory,
d) transmitting a compressed image data obtained by compressing the scanned image data from the first terminal to the second terminal through the network,
e) selecting, by the customer, a particular image data which the customer needs to print or download from the compressed image data transmitted to the second terminal,
f) transmitting the particular image data to order for printing the particular image data from the second terminal to the first terminal,
g) selecting the scanned image data stored in the first storage member according with the particular image data transmitted from the second terminal, and
h) printing at the processing laboratory the selected image data stored in the first storage member.

10. The method of claim 9, wherein a size of the compressed image data from the first terminal to the second terminal is determined by storage capability of the second terminal and transmittance speed to the second terminal.

11. The method of claim 9, wherein the second terminal has a second storage member for storing the image data to be downloaded from the first terminal.

12. The method of claim 11, the image data to be downloaded is higher resolution than the compressed image data from the first terminal to the second terminal.

13. The method of claim 12, the image data to be downloaded is downloaded to the second storage member installed at an internet service provider of the customer.

14. The method of claim 12, the image data to be downloaded is downloaded to the second storage member installed at the customer's home.

15. The method of claim 13, the compressed image data is transmitted in the form of thumbnail index.

16. The method of claim 14, the compressed image data is transmitted in the form of thumbnail index.

17. A method for ordering a reprint and sending an digital image from a processing laboratory having a first terminal to a customer having a second terminal through a network, comprising the steps of:
a) scanning an image data on an original,
b) linking the scanned image data with a customer identification information,
c) storing the scanned image data during prescribed time on a first storage member installed at a location accessible for a person in the processing laboratory,
d) printing the image data,
e) transmitting a compressed image data obtained by compressing the scanned image data from the first terminal to the second terminal through the network,
f) selecting, by the customer, a particular image data which the customer needs to reprint or download from the compressed image data transmitted to the second terminal,
g) transmitting the particular image data to order for reprinting the particular image data from the second terminal to the first terminal,
h) selecting the scanned image data stored in the first storage member according with the particular image data transmitted from the second terminal, and
h) reprinting at the processing laboratory the selected image data stored in the first storage member.
